(19) United States
(12) Patent Application Publication
(10) Pub. No.: US 2015/0049285 A1
(43) Pub. Date: Feb. 19, 2015

(54) Non-Planar Display Backlight Structures

(71) Applicant: Apple Inc., Cupertino, CA (US)

(72) Inventors: Amy Qian, San Jose, CA (US); Jeremy C. Franklin, San Francisco, CA (US); John Raff, Menlo Park, CA (US); Victor H. Yin, Cupertino, CA (US); Wenyong Zhu, San Jose, CA (US)

(73) Assignee: Apple Inc., Cupertino, CA (US)

(21) Appl. No.: 13/965,965

(22) Filed: Aug. 13, 2013

(51) Int. Cl. F21V 8/00; G02F 1/1335

(52) U.S. Cl. CPC G02B 6/0073; G02F 1/133514
USPC 349/106; 362/612; 362/615; 438/30

(57) ABSTRACT

An electronic device may be provided with a display. The display may include display layers characterized by an active area and backlight structures that provide backlight to the active area. To accommodate components such as a button, an edge portion of a light guide plate in the backlight structures that does not overlap the active area is bent out of the plane of the light guide plate. The bent edge portion of the light guide plate may be formed by molding clear plastic in a die or by bending a flexible sheet of clear polymer. Flared structures may be formed on the flexible sheet of clear polymer to help guide light from light-emitting diodes into the flexible sheet of clear polymer. The flared structures may be formed by applying resin coating layers to the flexible sheet of clear polymer.

### BACKGROUND

This relates generally to electronic devices and, more particularly, to electronic devices with backlit displays.

Electronic devices often include displays. For example, cellular telephones and portable computers often include displays for presenting information to users.

Displays are often provided with backlights. As an example, a liquid crystal display may have a backlight to ensure that images on the liquid crystal display are visible to users in a variety of lighting conditions.

A typical backlight has a rectangular planar light guide plate formed from clear plastic. Light-emitting diodes provide light to the edge of the light guide plate. Due to total internal reflection, the light is distributed throughout the light guide plate. Light scattering features are used to help scatter light outwardly from the light guide plate to serve as display backlight.

A minimum mixing distance is needed within the light guide plate to ensure that light from the light-emitting diodes is evenly distributed within the plate before being scattered outwardly as backlight. This minimum mixing distance imposes a minimum distance between the edge of the light guide plate and the edge of the active area of the display.

If care is not taken, backlight structures may be overly bulky. Configuring a display to provide an adequate mixing distance within a light guide plate and to provide sufficient room to accommodate the light-emitting diodes at the edge of the light guide plate may make the inactive border of the display larger than desired and may make it difficult to mount components in a device in the immediate proximity of the display.

It would therefore be desirable to be able to provide improved displays with backlights for electronic devices.

### SUMMARY

An electronic device may be provided with a display having backlight structures. The display may have an active area. The backlight structures may provide backlight to the active area. The backlight structures may have a light source such as an array of light-emitting diodes. The light-emitting diodes may emit light into the light guide plate. Light that scatters outwards from the light guide plate may serve as backlight for the active area of the display.

To accommodate components such as a button, an edge portion of a light guide plate in the backlight structures that does not overlap the active area is bent out of the plane of the light guide plate. The button or other components may lie above some of light-emitting diodes that emit light into the light guide plate and may lie above the bent edge portion of the light guide plate.

The bent edge portion of the light guide plate may be formed by molding clear plastic in a die or by bending a flexible sheet of clear polymer. Flared structures may be formed at the edges of the flexible sheet of clear polymer to help guide light from the light-emitting diodes into the flexible sheet of clear polymer. The flared structures may be formed by applying a resin coating to the flexible sheet of clear polymer.

Further features, their nature and various advantages will be more apparent from the accompanying drawings and the following detailed description of the preferred embodiments.

### BRIEF DESCRIPTION OF THE DRAWINGS

FIG. 1 is a perspective view of an illustrative electronic device with display structures in accordance with an embodiment.

FIG. 2 is a cross-sectional side view of an illustrative display of the type that may be used in an electronic device in accordance with an embodiment.

FIG. 3 is a cross-sectional side view of a portion of a display backlight having a backlight with a light guide plate that has a bent edge in accordance with an embodiment.

FIG. 4 is a cross-sectional side view of a component such as a button or other component that may be mounted adjacent to a display in a location that overlaps the bent edge region of a light guide plate in accordance with an embodiment.

FIG. 5 is a flow chart of illustrative steps involved in forming a light guide plate with a curved edge region in accordance with an embodiment.

FIG. 6 is a cross-sectional side view of illustrative display structures that include a light guide plate with a bent edge region such as a molded light guide plate in accordance with an embodiment.

FIG. 7 is a cross-sectional side view of illustrative display structures that include a light guide plate with a bent edge region such as a flexible light guide plate with a flared edge structure formed from resin coatings in accordance with an embodiment.

FIG. 8 is a top view of a portion of an electronic device in which a component such as a button has been mounted in space made available over a light guide plate by bending an edge of the light guide plate out of the plane of the light guide plate in accordance with an embodiment.

### DETAILED DESCRIPTION

Displays in electronic devices may be provided with backlights. A backlight in a display may have a light guide plate. The light guide plate may distribute light laterally across the display. Light that is scattered outwards from the surface of the light guide plate may serve as backlight for the display.

A light source such as an array of light-emitting diodes may provide light to the light guide plate. An edge portion of the light guide plate may be bent to help accommodate components in the vicinity of the display.

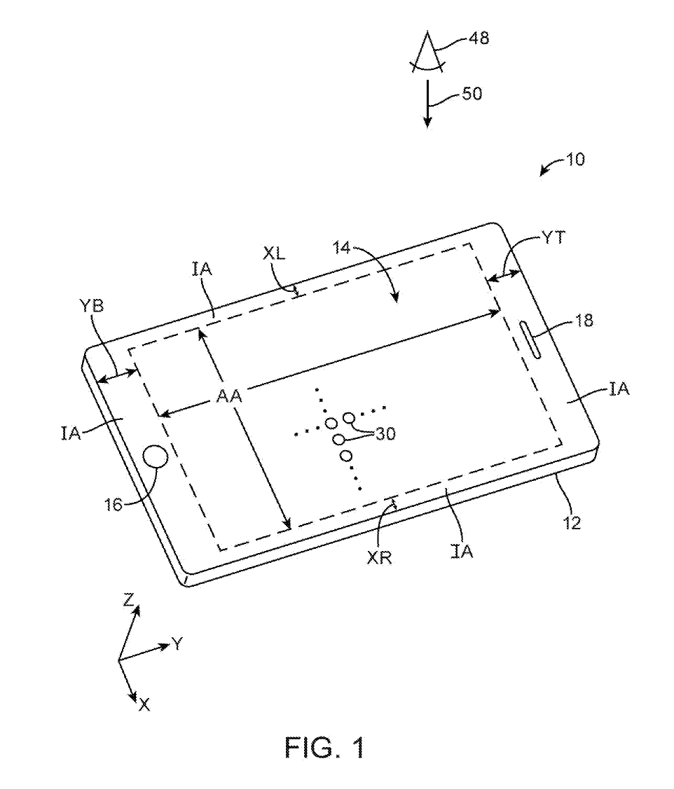

An illustrative electronic device of the type that may be provided with a display backlight having a bent light guide plate edge is shown in FIG. 1. Electronic device 10 may be a laptop computer, a computer monitor containing an embedded computer, a tablet computer, a cellular telephone, a media player, or other handheld or portable electronic device, a smaller device such as a wrist-watch device, a pendant device, a headphone or earpiece device, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment.

Device 10 may have one or more displays such as display 14 mounted in housing structures such as housing 12. Housing 12 of device 10, which is sometimes referred to as a case, may be formed of materials such as plastic, glass, ceramics, carbon-fiber composites and other fiber-based composites, metal (e.g., machined aluminum, stainless steel, or other metals), other materials, or a combination of these materials. Device 10 may be formed using a unibody construction in which most or all of housing 12 is formed from a single structural element (e.g., a piece of machined metal or a piece of molded plastic) or may be formed from multiple housing structures (e.g., outer housing structures that have been mounted to internal frame elements or other internal housing structures).

Display 14 may be a touch sensitive display that includes a touch sensor or may be insensitive to touch. Touch sensors for display 14 may be formed from an array of capacitive touch sensor electrodes, a resistive touch array, touch sensor structures based on acoustic touch, optical touch, or force-based touch technologies, or other suitable touch sensor components.

Display 14 for device 10 includes display pixels formed from liquid crystal display (LCD) components or other suitable image pixel structures.

A display cover layer may cover the surface of display 14 or a display layer such as a color filter layer or other portion of a display may be used as the outermost (or nearly outermost) layer in display 14. The outermost display layer may be formed from a transparent glass sheet, a clear plastic layer, or other transparent member. If desired, openings may be formed in the outermost layer of display 14 to accommodate components such as button 16 and speaker port 18 (as examples).

Display 14 may have an inactive portion such as inactive region IA that surrounds an active portion such as active region AA. Active region AA may, for example, form a rectangular central portion of display 14 (when viewed in direction 50 by viewer 48) and may be surrounded by an inactive region IA with the shape of a rectangular ring. Display 14 may have other active area shapes and inactive area shapes, if desired. Configurations in which an inactive region IA extends along each of the four edges of a rectangular active region AA are described herein as an example.

Active area AA contains an array of display pixels 30 that display images for viewer 48. Inactive area AA does not contain display pixels and does not display images. To block internal components from view, the underside of the outermost display layer in display 14 in inactive area IA may be coated with an opaque masking material such as a layer of opaque ink.

To enhance device aesthetics and to minimize device bulk, it may be desirable to minimize the widths associated with inactive border IA of display 14. For example, it may be desirable to minimize border widths YB, YT, XL, and XR. This helps reduce unsightly border areas and maximizes the size of active area AA relative to the size of the rest of display 14. Additional volume for mounting components near active area AA and border width reductions can be achieved by creating one or more bent edge portions bending edge portions of a display backlight light guide plate.

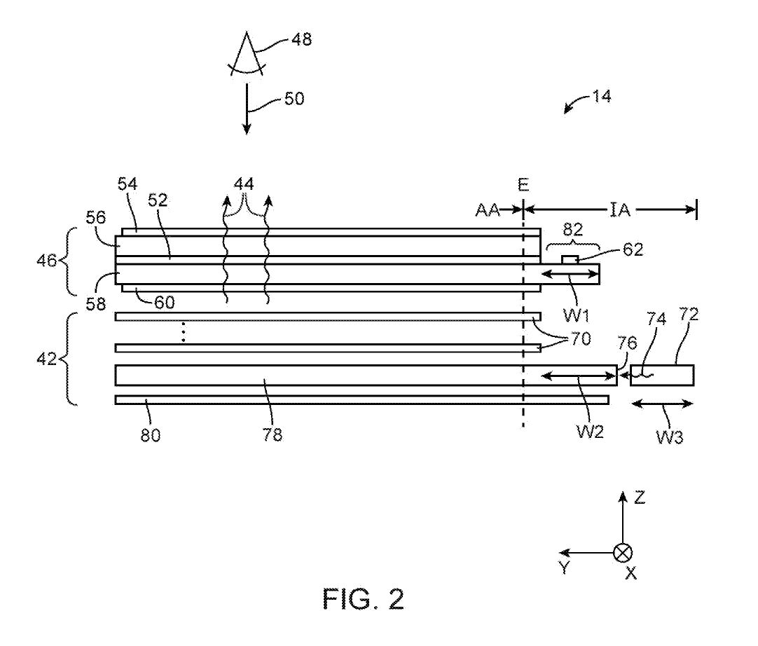

A cross-sectional side view of an illustrative configuration for display 14 of device 10 is shown in FIG. 2. Active area AA of display 14 contains an array of display pixels 30 (FIG. 1) formed from display layers 46. As shown in FIG. 2, display 14 includes backlight structures such as backlight unit 42 for producing backlight 44. During operation, backlight 44 travels outwards (vertically upwards in dimension Z in the orientation of FIG. 2) and passes through display pixels 30 in display layers 46. In this way, backlight 44 illuminates images on display layers 46 that are being viewed by viewer 48 in direction 50.

Display layers 46 may be mounted in chassis structures such as a plastic chassis structure and/or a metal chassis structure to form a display module for mounting in housing 12 or display layers 46 may be mounted directly in housing 12 (e.g., by stacking display layers 46 into a recessed portion or other structures in housing 12). Display layers 46 may form a liquid crystal display or may be used in forming displays of other types.

In a configuration in which display layers 46 are used in forming a liquid crystal display, display layers 46 include a liquid crystal layer such a liquid crystal layer 52. Liquid crystal layer 52 is sandwiched between display layers such as display layers 58 and 56. Layers 56 and 58 are interposed between lower polarizer layer 60 and upper polarizer layer 54.

Layers 58 and 56 are formed from transparent substrate layers such as clear layers of glass or plastic. Layers 56 and 58 are layers such as a thin-film transistor layer (e.g., a thin-film-transistor substrate such as a glass layer coated with a layer of thin-film transistor circuitry) and/or a color filter layer (e.g., a color filter layer substrate such as a layer of glass having a layer of color filter elements such as red, blue, and green color filter elements arranged in an array). Conductive traces, color filter elements, transistors, and other circuits and structures are formed on the substrates of layers 58 and 56 (e.g., to form a thin-film transistor layer and/or a color filter layer). Touch sensor electrodes may also be incorporated into layers such as layers 58 and 56 and/or touch sensor electrodes may be formed on other substrates.

With one illustrative configuration, layer 58 is a thin-film transistor layer that includes an array of thin-film transistors and associated electrodes (display pixel electrodes) for applying electric fields to liquid crystal layer 52 and thereby displaying images on display 14. Layer 56 is a color filter layer that includes an array of color filter elements for providing display 14 with the ability to display color images. If desired, the color filter layer may be placed on the inner surface of display 14 and the thin-film transistor layer may be placed on the outer surface of display 14.

During operation of display 14 in device 10, control circuitry (e.g., one or more integrated circuits mounted on a printed circuit in device 10) may be used to generate information to be displayed on display 14 (e.g., display data). The information to be displayed may be conveyed to display driver circuitry such as display driver integrated circuit 62 using a signal path such as a signal path formed from conductive metal traces in a flexible printed circuit (as an example).

Display driver circuitry such as display driver integrated circuit 62 of FIG. 2 may be mounted on thin-film-transistor layer driver ledge 82 of thin-film transistor layer 58 or elsewhere in device 10. A flexible printed circuit cable may be used in routing signals between a main logic board or other printed circuit and thin-film-transistor layer 58. If desired, display driver integrated circuit 62 may be mounted on a printed circuit that is coupled to thin-film transistor layer 58 at ledge 82. Printed circuits for mounting display circuitry and other circuitry in device 10 may be formed from a rigid printed circuit board material (e.g., a layer of fiberglass-filled epoxy) or may be formed using one or more flexible printed circuit substrates (e.g., a flexible sheet of polyimide or other flexible polymer layer).

Backlight structures 42 include a light guide plate such as light guide plate 78. Light guide plate 78 is formed from a transparent material such as clear glass or plastic. In a configuration in which display 14 has a rectangular footprint in the X-Y plane (i.e., a rectangular outline when viewed in direction 50 by viewer 38), light guide plate 78 may have a rectangular shape.

During operation of backlight structures 42, a light source such as light source 72 generates light 74. Light source 72 may be, for example, an array of light-emitting diodes. Light-emitting diodes 72 may run along one or more of the edges of light guide plate 78. In the illustrative configuration of FIG. 2, light-emitting diodes 72 run along the right-hand edge of light guide plate 78 (i.e., along dimension X).

During operation, light 74 from one or more light sources such as light-emitting diode(s) 72 is coupled into one or more corresponding edge surfaces such as edge surface 76 of light guide plate 78 and is distributed in dimensions X and Y throughout light guide plate 78 due to the principal of total internal reflection. Light guide plate 78 may have light-scattering features such as pits and bumps. The light-scattering features may be located on the upper surface and/or on the opposing lower surface of light guide plate 78.

Light 74 that scatters upwards in direction Z from light guide plate 78 serves as backlight 44 for display 14. Light 74 that scatters downwards is reflected back in the upwards direction by reflector 80. Reflector 80 may be formed from a reflective material such as a layer of white plastic or other shiny materials.

To enhance backlight performance for backlight structures 42, backlight structures 42 may include optical films 70. Optical films 70 may include diffuser layers for helping to homogenize backlight 44 and thereby reduce hotspots, compensation films for enhancing off-axis viewing, and brightness enhancement films (also sometimes referred to as turning films) for collimating backlight 44. Optical films 70 may overlap the other structures in backlight unit 42 such as light guide plate 78 and reflector 80. For example, if light guide plate 78 has a rectangular footprint in the X-Y plane of FIG. 2, optical films 70 and reflector 80 preferably have a corresponding rectangular shape.

As illustrated by inactive border region IA on the right-hand side of FIG. 2, display 14 may be characterized by an active area AA that contains an array of display pixels 30 and may be surrounded by inactive border regions IA. Inactive border regions IA, which do not contain display pixels 30 for creating images for viewing by viewer 48, may overlap internal components such as display driver integrated circuit 62, traces that mate with the tip of a flexible printed circuit cable on thin-film transistor driver ledge 82, and light-emitting diodes 72.

Light-emitting diodes 72 may emit light 74 into edge surface 76 of light guide plate 78 at discrete locations along the edge of light guide plate 78. To avoid hotspots (locally brighter backlight regions), an adequate mixing distance W2 should generally be provided between exposed outer vertical edge 76 of light guide plate 78 and the adjacent edge E (i.e., the periphery) of active area AA. If mixing distance W2 is too small, hotspots may be visible to viewer 48. There is also a finite lateral size W3 associated with light-emitting diodes 72.

The use of a minimum mixing distance W2 and the desire to maintain sufficient room to accommodate diode width W3 along the edge of display 14 limits the minimum size of the border of device 14. Moreover, when space along the edge of the display is occupied by the portion of light guide plate 78 that is used in providing minimum mixing distance W2 and is occupied by light-emitting diodes 72, there is limited room available for additional device components such as button 16 of FIG. 1.

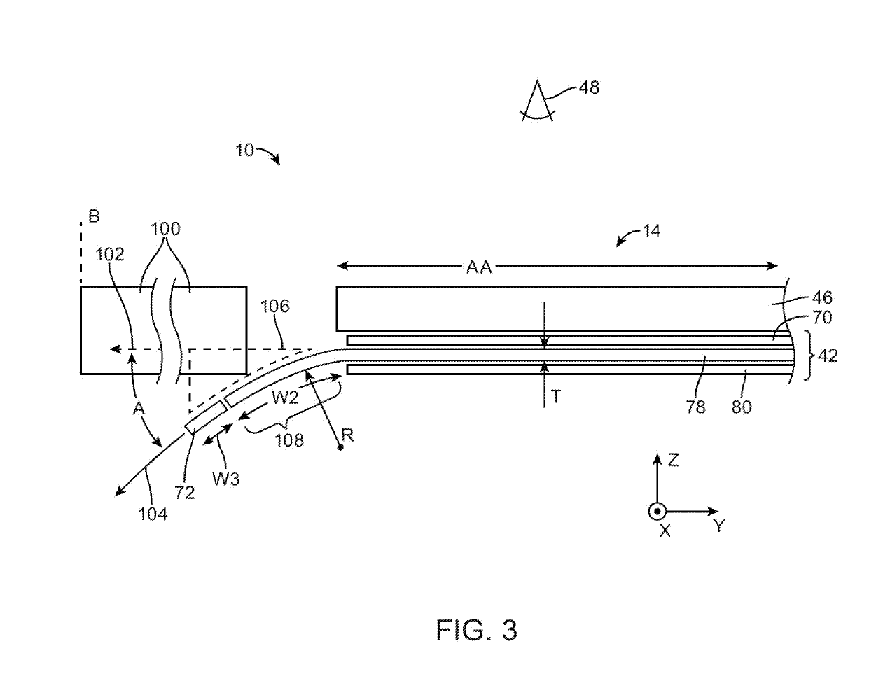

To address these constraints, the design of FIG. 2 in which light guide plate 78 has a planar shape with unbent edges may be modified so that one or more edges of light guide plate 78 are bent. In an arrangement of this type in which one or more edge regions of light guide plate 78 are bent out of the plane of the light guide plate 78, space within display 14 may be made available to accommodate buttons and other device components without sacrificing mixing distance W2 or diode width W3. This type of arrangement for backlight 42 in display 14 and device 10 is shown in FIG. 3.

As shown in FIG. 3, light guide plate 78 may have bent edge portion 108. In the example of FIG. 3, bent edge portion 108 is bent downward (in the orientation of FIG. 3). In general, bent edge portions of light guide plate 78 may be bent upwards and/or downwards out of the plane of light guide plate (i.e., out of the X-Y plane in FIG. 3). Bent edge portion 108 does not overlap active area AA.

Bent edge portion 108 may be characterized by a maximum angular deformation A. Angle A may represent the angle between horizontal axis 102, which lies in the X-Y plane of light guide plate 78, and the axis 104, which is aligned with the surface of the tip of bent edge portion 108. Angle A may be, for example, an angle in the range of 1° to 30°, an angle in the range of 2° to 20°, an angle in the range of 0.5° and 10°, an angle in the range of 5° to 20°, an angle less than 45°, an angle greater than 5°, or other suitable angle.

By incorporating bent edge portion 108 into light guide plate 78, mixing distance W2 may be maintained between light-emitting diode 72 and edge E of active area AA even when components are mounted in device 10 adjacent to active area AA. Light leakage in light guide plate 78 due to the bending of portion 108 of light guide plate may be minimized by limiting the bend radius R of light guide plate 78 in region 108. As an example, bend radius R may be in the range of 2-30 mm, in the range of 3-20 mm, in the range of 4-20 mm, in the range of 5-12 mm, in the range of 10-20 mm, less than 20 mm, more than 3 mm, more than 5 mm, or may have other suitable values. The thickness T of light guide plate 78 may be in the range of 0.1 mm to 1 mm, in the range of 0.2 mm to 0.8 mm, in the range of 0.2 mm to 0.4 mm, in the range of 0.4 mm to 0.8 mm, greater than 0.4 mm, greater than 0.1 mm, less than 1 mm, less than 0.6 mm, less than 0.3 mm, or other suitable thickness.

As shown in FIG. 3, when edge portion 108 of light guide plate 78 is bent, space within device 10 becomes available for mounting device components adjacent to display 14. For example, volume 106 may be made available adjacent to display structures such as display layers 46 for the mounting of components such as illustrative component 100. If portion 108 were to extend horizontally outward, component 100 would need to be moved to the left (i.e., left edge B of component 100 would be located further from display layers 46), thereby enlarging the lateral dimension of device 10. When volume 106 is used, component 100 can be located nearer display layers 46 and some or all of component 100 can lie below the lowest layer in display layers 46 (i.e., below horizontal axis 102 in FIG. 3). This allows component 100 to be relatively thick, if desired.

Component 100 may be a button such as button 16 of FIG. 1, a speaker (e.g., a speaker in speaker port 18 of FIG. 1), an input-output component, an audio component, a connector, a switch, an integrated circuit, a printed circuit board, a sensor, a status indicator device, a wireless component such as an antenna, a housing frame or other housing structure, or any other structure or electrical component in device 10.

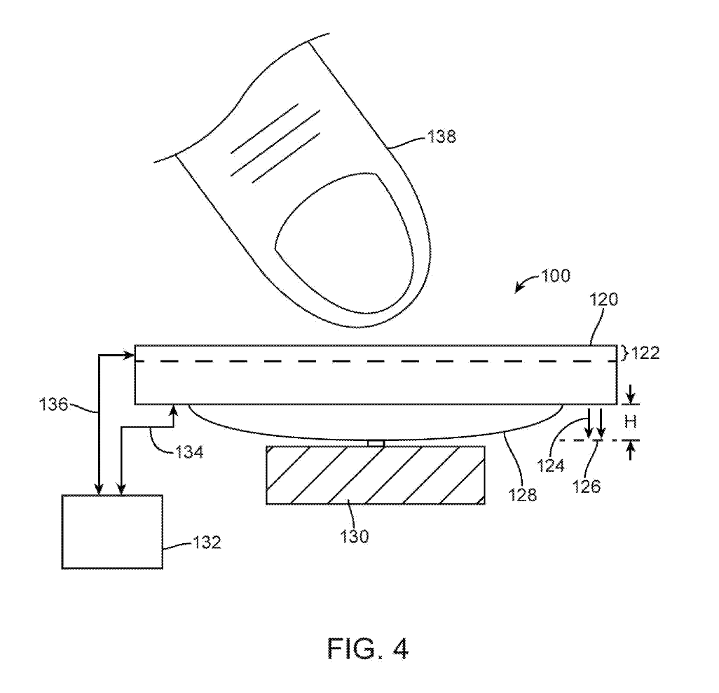

FIG. 4 is a cross-sectional side view of an illustrative component that may be mounted in a portion of device 10 such as region 106 above bent edge region 108 of light guide plate 78. Component 100 may include button structures such as button member 120 and dome switch 128 or other switching structures. When a user's finger such as finger 138 presses against button member 120, button member 120 may move in direction 124 until the lower edge of button member 120 is aligned with dashed line 126. By placing component 100 in region 106, space is made available within device 10 to accommodate movement of button member 120 in direction 124 (i.e., space is made available to allow button member 120 to be depressed a distance H). Buttons that use touch sensors instead of dome switches and that do not exhibit appreciable movement in direction 124 may also be used in region 106 of device 10 if desired.

In the illustrative configuration of FIG. 4, dome switch 128 bears against internal housing structure 130. Control circuitry 132 may use signals on path 134 to monitor the state of switch 128. When compressed sufficiently, switch 128 may transition from an open state to a closed state. Control circuitry 132 can take actions based on the state of switch 128.

If desired, switch 128 may be implemented using a capacitive touch sensor (e.g., in an arrangement in which button member 120 does not move or moves without compressing switch 128). Fingerprint sensing structures may also be implemented in component 100. As shown in FIG. 4, control circuitry 132 may use path 136 to handle signals associated with the operation of portion 122 of button member 120. Portion 122 may include capacitive touch sensor structures, fingerprint sensor structures, light-emitting status indicator structures, display structures, and other circuitry.

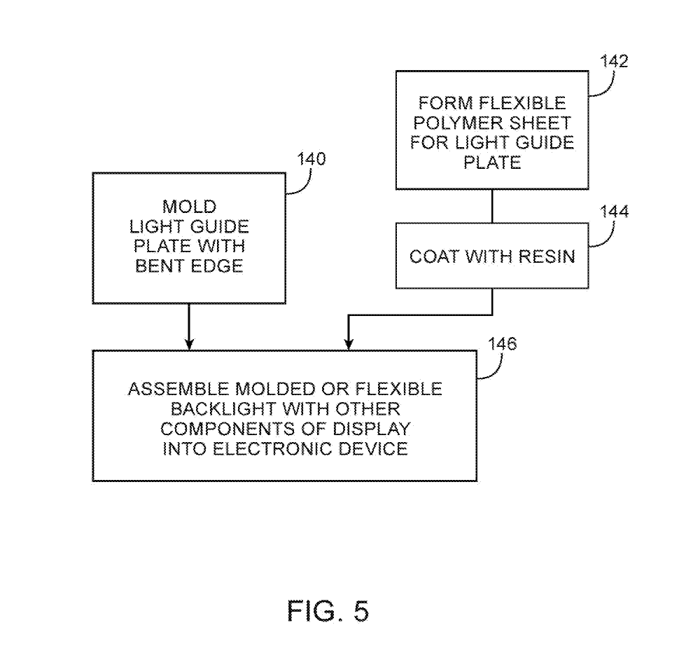

Bent light guide structures may be formed using plastic molding techniques, techniques in which liquid resin is applied to a flexible light guide plate that is flexed into shape, or other suitable fabrication techniques. A flow chart of illustrative steps involved in forming a display having a light guide plate with one or more bent edge regions is shown in FIG. 5.

Molding techniques may be performed at step 140. During the operations of step 140, light guide plate 78 may be formed by molding clear plastic in a plastic molding die. Heat and pressure may be applied using the die (mold). The interior cavity of the die may lie a plane that defines a resulting planar shape for light guide plate 78. The die may include one or more bent edge regions so that one or more edges of the light guide plate are angled away from the plane of the planar light guide plate at non-zero angles. After molding the plastic of the light guide plate into a desired shape with one or more bent edge regions, the die may be opened and the light guide plate removed. The molded plastic light guide plate may include integrally formed pits, bumps, or other light scattering features for promoting light scattering to produce backlight 44.

In configurations in which the light guide plate is sufficiently flexible to bend without molding, a polymer sheet for forming the light guide plate may be formed at step 142. During the operations of step 142, a roll-to-roll process or other process may be used to produce a polymer layer having a thickness and composition that allows the polymer layer to flex without cracking. The polymer layer may, for example, be formed from a polymer material such as polyethylene terephthalate (PET) having a thickness of 0.25 mm, having a thickness of 0.1 to 0.6 mm, having a thickness of less than 1 mm, having a thickness of less than 0.6 mm, having a thickness of less than 0.4 mm, having a thickness of less than 0.3 mm, having a thickness of more than 0.1 mm, or having another suitable thickness. Light scattering features such as pits or bumps may, if desired, be added to the surface of light guide plate 78 using protrusions or recesses on the rollers that are being used to form the flexible light guide plate or may be incorporated into subsequently deposited resin layers.

Following formation of the sheet of flexible light guide plate material at step 142, resin may be applied to the surfaces of the light guide plate material. A resin such as a PET adhesive or other resin that is matched to the index of refraction of the PET layer may be applied. Light scattering features such as pits or bumps may be formed as part of the resin application process. Rollers or other resin application equipment may be used in applying the resin. Resin may be applied in different thicknesses to different portions of the polymer layer for the light guide plate. As an example, a locally thickened resin may be applied near an edge of the layer of polymer. The locally thickened resin may create flared structures that serve as a coupling structure that enhances light collection from a light-emitting diode. The light-emitting diode may emit light in a beam that is thicker than the thickness of the layer of polymer. By locally thickening the edge of the light guide plate material in this way, light coupling of the beam into the interior of the light guide plate may be enhanced. The applied resin may be cured thermally or by applying ultraviolet light.

The molded light guide plate from step 140 or the flexible light guide plate with edges that can be flexed into a bent edge shape from steps 142 and 144 may be assembled together with other display backlight structures and other electronic device structures during the operations of step 146. For example, the light guide plate may be installed within metal chassis structures, plastic chassis structures, and/or housing structures. In configurations in which the light guide plate is flexible, the process of installing the light guide plate in the chassis or housing structures may involve flexing the light guide plate into a desired configuration with one or more bent edge regions. Display 14 may be formed during the assembly operations of step 146 (e.g., by installing display layers 46 above display backlight 44). If desired, components such as component 100 may be installed within device 10 in the space made available by the bent edges of light guide plate 78.

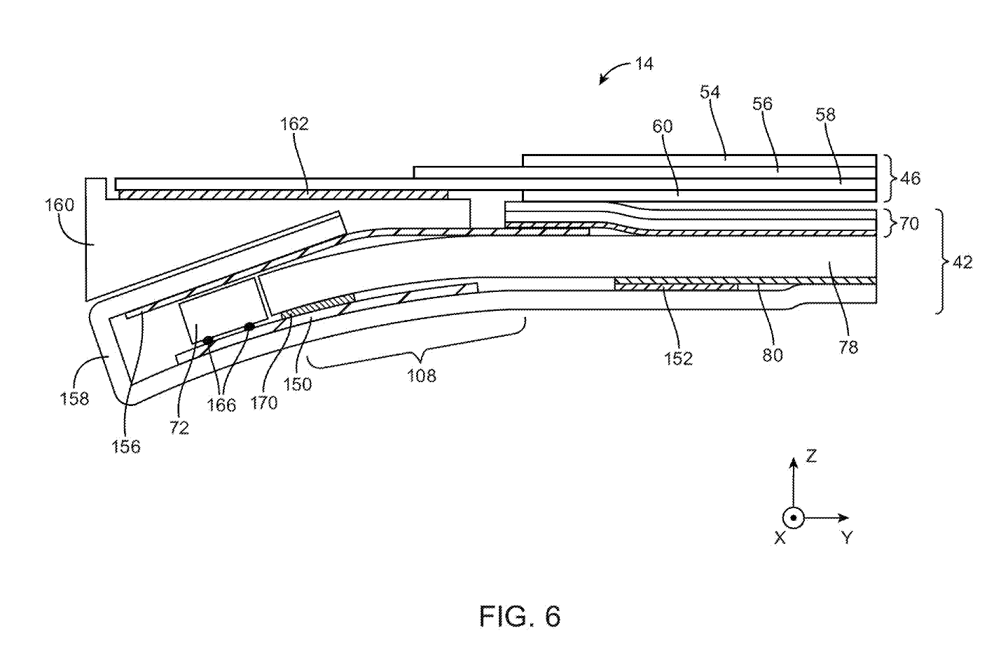

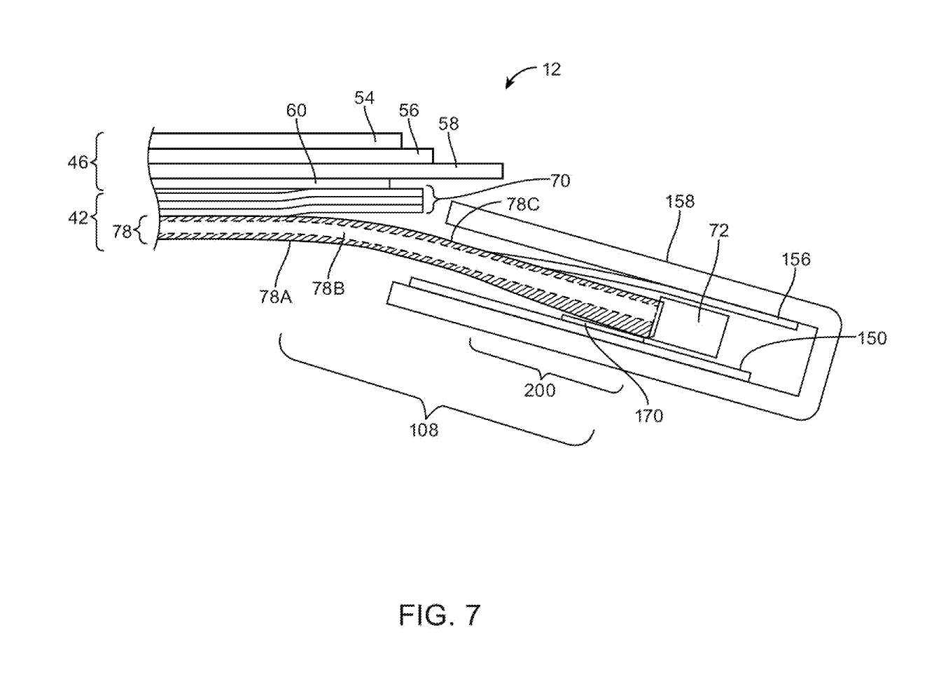

Illustrative configurations for display 14 are shown in FIGS. 6 and 7.

In the configuration of FIG. 6, light guide plate 78 is mounted within chassis 158 (e.g., a metal chassis). Chassis 158 may, if desired, be coupled to plastic chassis structures. Solder 166 may be used to solder light-emitting diode 72 to flexible printed circuit 150. Flexible printed circuit 150 may be formed from a sheet of polyimide or a flexible layer of other polymer material. Traces on flexible printed circuit 150 may be used to route power to an array of light-emitting diodes 72 running along the edge of light guide plate 78. Adhesive 166 may be used to attach light-guide plate 78 to flexible printed circuit 150.

Top reflector 156 may be used to help reflect light from light emitting diodes 72 towards light guide plate 78 and to help prevent light leakage from backlight 42. Lower reflector 80 may be attached to chassis 158 using adhesive 152. Adhesive 162 may be used to attach thin-film transistor layer 58 to housing structure 160. Components such as component 100 may occupy some of the volume above bent portion 108 at other positions along the edge of light guide plate 78 (i.e., at other positions along the X axis of FIG. 6). If desired, a conductive fabric layer may be warped over the end of display 14 to help reduce electromagnetic interference.

In the illustrative configuration of FIG. 7, light guide plate 78 has been provided with resin coatings 78A and 78C on the lower and upper surfaces of flexible polymer layer 78B, respectively. Flexible polymer layer 78B may be sufficiently flexible to bend edge portion 108 of light guide plate 78 into a desired bent shape. Light-emitting diode 72 may be mounted adjacent to light guide plate 78. Resin coatings 78A and 78C may be locally thickened to create flared end 200 to light guide plate 78. Flared structures 200 on the bent edge of light guide plate 78 may help guide light from light-emitting diode 72 into light guide plate 78 (e.g., in configurations in which light guide plate 78 is thinner than light-emitting diode 72). The thickness of light guide plate 78 in flared region 200 may be, for example, 0.4 to 0.6 mm (e.g., in a configuration in which the main planar portion of light guide plate 78 is about 0.25 mm thick). Flexible light guide plates and flared structures with other configurations and dimensions may be used if desired. The example of FIG. 7 is merely illustrative.

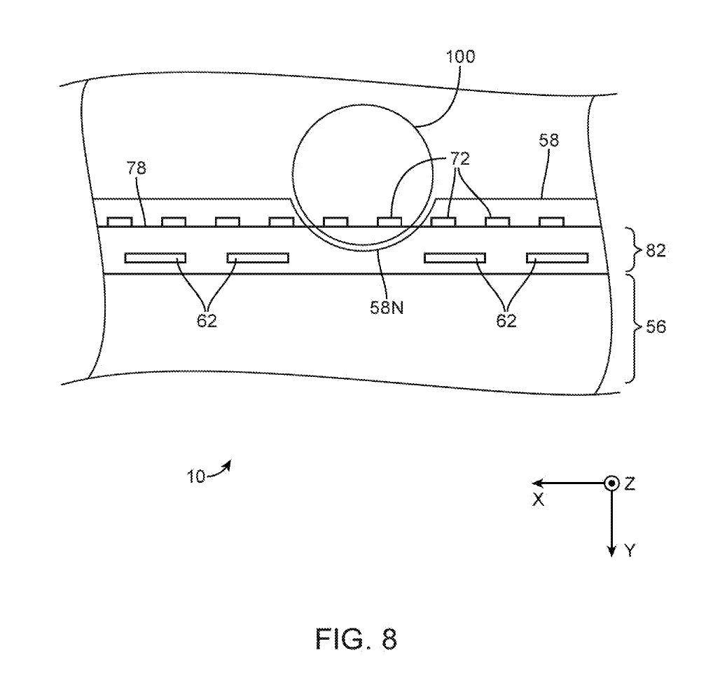

FIG. 8 is a top view of device 10 showing how a button or other component 100 may overlap an array of light-emitting diodes 72 running along the edge of light guide plate 78 under thin-film transistor layer 58. Because light guide plate 78 is bent downwards under component 100 (into the page in the orientation of FIG. 8), light-emitting diodes 72 and the edge of light guide plate 78 will not interfere with component 100 even though component 100 overlaps some of light-emitting diodes 72. The mounting of component 100 in device 10 over the bent edge region 108 of light guide plate 78 therefore allows component 100 to be moved further inwards in direction Y than would otherwise be possible, thereby helping to reduce the footprint of device 10 in the X-Y plane. If desired, a notch such as notch 58N may be provided in thin-film transistor layer 58 to further help accommodate movement of component 100 in direction Y.

The foregoing is merely illustrative and various modifications can be made by those skilled in the art without departing from the scope and spirit of the described embodiments. The foregoing embodiments may be implemented individually or in any combination.

What is claimed is:

1. A display, comprising:
display layers; and
backlight structures that backlight the display layers, wherein the backlight structures include a light guide plate and a light-emitting diode that emits light, wherein the light guide plate has at least one planar region and at least one bent edge region that is bent at a non-zero angle with respect to the planar region, and wherein the light guide plate receives the light from the light-emitting diode through the bent edge region.

2. The display defined in claim 1 wherein the display layers comprise:
a color filter layer;
a thin-film transistor layer; and
a layer of liquid crystal material between the color filter layer and the thin-film transistor layer.

3. The display defined in claim 1 wherein the bent edge region is characterized by a bend radius of three to twenty millimeters.

4. The display defined in claim 1 wherein the light guide plate comprises a molded clear plastic plate.

5. The display defined in claim 1 wherein the light guide plate comprises a flexible sheet of clear polymer that is bent to create the bent edge region.

6. The display defined in claim 5 further comprising at least one resin coating on the flexible sheet of clear polymer.

7. The display defined in claim 5 wherein the flexible sheet of clear polymer has opposing upper and lower surfaces, the display further comprising a first resin coating on the upper surface and a second resin coating on the lower surface.

8. The display defined in claim 5 further comprising resin coating on the flexible sheet of clear polymer that forms a flared structure that couples light from the light-emitting diode into the bent edge region.

9. An electronic device comprising:
a housing;
a display having a light guide plate with a bent edge region; and
a component mounted in the housing over the bent edge region.

10. The electronic device defined in claim 9 wherein the component comprises a button.

11. The electronic device defined in claim 9 wherein the display has a light-emitting diode that emits light into the bent edge region.

12. The electronic device defined in claim 9 wherein the light guide plate has a planar portion and wherein the bent edge region bends away from the planar portion with a bend radius of three to twenty millimeters.

13. The electronic device defined in claim 12 wherein the light guide plate comprises a flexible clear polymer sheet having a thickness of less than 0.4 mm.

14. The electronic device defined in claim 12 wherein the light guide plate comprises a molded clear plastic structure.

15. The electronic device defined in claim 9 wherein the component comprises a fingerprint sensor.

16. The electronic device defined in claim 9 further comprising a plurality of light-emitting diodes that emit light into the bent edge region, wherein the component overlaps at least one of the light-emitting diodes.

17. The electronic device defined in claim 16 wherein the component comprises a button.

18. A method of forming a display, comprising:
forming liquid crystal display layers that include a thin-film transistor layer, a color filter layer, and a layer of liquid crystal material between the thin-film transistor layer and the color filter layer, wherein the liquid crystal display layers are characterized by an active area; and
forming a light guide plate having a planar region that lies in a plane and that overlaps the liquid crystal display layers and having a bent edge region that bends out of the plane and that does not overlap the active area.

19. The method defined in claim 18 wherein forming the light guide plate comprises:
applying a resin coating to a flexible clear layer of polymer; and
bending the flexible clear layer of polymer to form the bent edge region.

20. The method defined in claim 18 wherein forming the light guide plate comprises molding the bent edge region within a die.
